(19) United States
(12) Patent Application Publication
(10) Pub. No.: US 2025/0157206 A1
(43) Pub. Date: May 15, 2025

(54) METHOD AND APPARATUS WITH MAP CONSTRUCTION

(71) Applicant: Samsung Electronics Co., Ltd., Suwon-si (KR)

(72) Inventors: Yi ZHOU, Beijing (CN); Hui ZHANG, Beijing (CN); Byung In YOO, Suwon-si (KR); Seungin PARK, Suwon-si (KR); Sangil JUNG, Suwon-si (KR); Xiaoshuai HAO, Beijing (CN)

(73) Assignee: Samsung Electronics Co., Ltd., Suwon-si (KR)

(21) Appl. No.: 18/946,809

(22) Filed: Nov. 13, 2024

(30) Foreign Application Priority Data
Nov. 15, 2023 (CN) 202311527475.1
Oct. 17, 2024 (KR) 10-2024-0142233

(51) Int. Cl. G06V 10/80; G06V 10/764; G06V 10/77; G06V 10/774

(52) U.S. Cl. CPC G06V 10/806; G06V 10/764; G06V 10/7715; G06V 10/774

(57) ABSTRACT

A high-definition (HD) map-related map construction method, electronic device, and storage medium are provided. The method includes: extracting a bird's-eye view (BEV) feature map based on the data; determining map information through a hybrid decoder based on the BEV feature map and a hybrid query; and constructing an HD map corresponding to the data based on the map information, wherein the map includes a plurality of map elements each including an area formed by a plurality of coordinate points in the map, the map information comprises coordinate information and class information of the plurality of map elements, and the hybrid query includes a plurality of hybrid features each corresponding to one map element and including a point feature and an element feature. Optionally, the method may be executed using an artificial intelligence (AI) model.

### CROSS-REFERENCE TO RELATED APPLICATIONS

This application claims the benefit under 35 USC § 119 (a) of Chinese Patent Application No. 202311527475.1 filed on Nov. 15, 2023, in the China National Intellectual Property Administration, and Korean Patent Application No. 10-2024-0142233 filed on Oct. 17, 2024, in the Korean Intellectual Property Office, the entire disclosures of which are incorporated herein by reference for all purposes.

### BACKGROUND

### 1. Field

The following description relates to the technical field of high-definition (HD) map construction and, more particularly, to a method and apparatus with map construction.

### 2. Description of Related Art

High-definition (HD) map construction may be considered a task of predicting a set of vectorized static map elements from a bird's-eye view (BEV), and element categories (or classes) of the map elements may include a pedestrian crossing, a lane divider, a road boundary line, and the like. An HD map may provide rich and accurate static environmental information about a driving scene, and the HD map construction may thus be an important and challenging task for downstream tasks such as autonomous driving system planning, automatic HD map annotation systems, and the like.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One or more general aspects of the present disclosure are to provide a method and apparatus with map construction to solve the preceding challenges of the related art.

In a general aspect, here is provided a map construction method including: extracting a bird's-eye view (BEV) feature map based on input data; determining map information through a hybrid decoder based on the BEV feature map and a hybrid query; and constructing a high-definition (HD) map corresponding to the input data based on the map information, wherein the HD map comprises a plurality of map elements, wherein the map information comprises coordinate information and class information of the plurality of map elements, wherein each of the plurality of map elements comprises an area formed by a plurality of coordinate points in the HD map, wherein the hybrid query comprises a plurality of hybrid features, wherein each of the plurality of hybrid features comprises a point feature and an element feature corresponding to a map element, wherein the point feature represents information associated with each coordinate point of the map element, and wherein the element feature represents information associated with the map element.

The determining of the map information through the hybrid decoder based on the BEV feature map and the hybrid query includes: decomposing the hybrid query into a first point query and a first element query, wherein the first point query comprises a first point feature corresponding to each coordinate point of each map element, and the first element query comprises a first element feature corresponding to each map element; determining a second point query and a second element query, based on the BEV feature map, the first point query, the first element query, and current map information; updating the hybrid query by fusing the second point query and the second element query; and iteratively updating the current map information based on the BEV feature map and the updated hybrid query to generate final map information, wherein the constructing of the HD map corresponding to the input data based on the map information includes: constructing the HD map corresponding to the input data based on the final map information.

The determining of the second point query and the second element query, based on the BEV feature map, the first point query, the first element query, and the current map information includes: for each of a plurality of anchor points, determining a second point feature based on the BEV feature map, the first point feature, and coordinate information of a corresponding anchor point, wherein the corresponding anchor point comprises a coordinate point corresponding to the first point feature; obtaining the second point query by fusing determined second point features; for each of the map elements, determining a second element feature of a corresponding map element, based on the BEV feature map, a first point feature of the corresponding map element, and coordinate information of each of a plurality of anchor points of the corresponding map element; and obtaining the second element query by fusing determined second element features.

The determining of the second point feature based on the BEV feature map, the first point feature, and the coordinate information of the corresponding anchor point, for each of the plurality of anchor points, includes: for each of the plurality of anchor points, determining a plurality of sampling points associated with the corresponding anchor point on the HD map, based on the coordinate information of the anchor point and the first point feature; obtaining a third point feature through fusion based on the BEV feature map and coordinate information and a weight of each of the plurality of sampling points; and determining the second point feature based on the first point feature and the third point feature.

The determining of the plurality of sampling points associated with the corresponding anchor point on the HD map, based on the coordinate information of the anchor point and the first point feature, for each of the plurality of anchor points, includes: determining a fourth point feature based on the coordinate information of the corresponding anchor point and the first point feature; determining a sampling offset and the weight of each of the plurality of sampling points based on the fourth point feature, wherein the sampling offset represents a degree of positional offset of a sampling point corresponding to the anchor point; and determining coordinate information of each of the plurality of sampling points, based on the coordinate information of the anchor point and the sampling offset of each of the plurality of sampling points.

The determining of the fourth point feature based on the coordinate information of the corresponding anchor point and the first point feature includes: obtaining a position embedding by encoding the coordinate information of the corresponding anchor point; and determining the fourth point feature, based on the first point feature and the position embedding.

The obtaining of the third point feature through the fusion based on the BEV feature map and the coordinate information and the weight of each of the plurality of sampling points includes: determining a sampling feature corresponding to each of the plurality of sampling points, based on the BEV feature map and the coordinate information of each of the plurality of sampling points; and obtaining the third point feature by fusing determined sampling features respectively corresponding to the plurality of sampling points, based on the weight of each of the plurality of sampling points.

The determining of the second element feature of the corresponding map element based on the BEV feature map, the first element feature of the corresponding map element, and the coordinate information of each of the plurality of anchor points of the corresponding map element, for each of the map elements, includes: for each of the map elements, obtaining a position embedding of each of the plurality of anchor points by encoding the coordinate information of each of the plurality of anchor points; obtaining a position embedding of the corresponding map element by fusing obtained respective position embeddings of the plurality of anchor points; and determining the second element feature of the corresponding map element, using a masked-attention module of the hybrid decoder, based on the BEV feature map, the first element feature, and the position embedding of the corresponding map element, wherein a mask of the masked-attention module is obtained based on mask information of each pixel, wherein the mask information represents a probability that each pixel belongs to the corresponding map element.

The iteratively updating of the hybrid query by fusing the second point query and the second element query includes: obtaining a fifth point query and a fifth element query by processing the second point query and the second element query, respectively, using a self-attention module of the hybrid decoder; obtaining a sixth element query by transforming the fifth point query into the same dimension as the fifth element query and fusing the fifth element query and the transformed fifth point query; obtaining a sixth point query by transforming the fifth element query into the same dimension as the fifth point query and fusing the fifth point query and the transformed fifth element query; and obtaining the updated hybrid query by fusing the sixth point query and the sixth element query.

In the method, a loss function used by the hybrid decoder during a training process includes a point-element consistency loss, wherein the point-element consistency loss is used to represent a level of risk of inconsistency between a point query and an element query of the updated hybrid query.

The method further includes: determining a value of the point-element inconsistency loss, wherein the determining of the value of the point-element inconsistency loss includes: obtaining point-level information and element-level information by transforming the point query and the element query of the updated hybrid query, respectively; obtaining pseudo-element-level information by fusing coordinate point information, in the point-level information, belonging to a same map element; and determining the value of the point-element consistency loss based on the pseudo-element-level information and the element-level information such that it represents a level of risk of inconsistency between the pseudo-element level information and the element level information.

The loss function used by the hybrid decoder during the training process further comprises at least one of a semantic segmentation loss, a classification loss, a point regression loss, a point orientation loss, or a mask loss.

In another general aspect, an electronic device may include at least one processor; and at least one memory storing computer-executable instructions, wherein, when the instructions are executed by the at least one processor, the at least one processor is configured to: extract a bird's-eye view (BEV) feature map based on the input data; determine map information through a hybrid decoder based on the BEV feature map and a hybrid query; and construct a high-definition (HD) map corresponding to the input data based on the map information, wherein the HD map comprises a plurality of map elements, wherein the map information comprises coordinate information and class information of the plurality of map elements, wherein each of the plurality of map elements comprises an area formed by a plurality of coordinate points in the HD map, wherein the hybrid query comprises a plurality of hybrid features, wherein each of the plurality of hybrid features comprises a point feature and an element feature corresponding to a map element, wherein the point feature represents information associated with each coordinate point of the map element, and the element feature represents information associated with the map element.

A computer-readable storage medium storing instructions, wherein the instructions, when executed by at least one processor, cause the at least one processor to implement the above method.

The method may further include using at least one sensor to collect sensor data as the input data.

In the electronic device, in the determining of the map information through the hybrid decoder based on the BEV feature map and the hybrid query, the at least one processor may be further configured to decompose the hybrid query into a first point query and a first element query, wherein the first point query comprises a first point feature corresponding to each coordinate point of each map element, and the first element query comprises a first element feature corresponding to each map element; determine a second point query and a second element query, based on the BEV feature map, the first point query, the first element query, and current map information; updating the hybrid query by fusing the second point query and the second element query; and iteratively update the current map information based on the BEV feature map and the updated hybrid query to generate final map information, wherein in the constructing of the HD map corresponding to the input data based on the map information, the at least one processor may be further configured to construct the HD map corresponding to the input data based on the final map information.

In the determining of the second point query and the second element query, based on the BEV feature map, the first point query, the first element query, and the current map information, the at least one processor may be further configured to: for each of a plurality of anchor points, determine a second point feature based on the BEV feature map, the first point feature, and coordinate information of a corresponding anchor point, wherein the corresponding anchor point comprises a coordinate point corresponding to the first point feature; obtain the second point query by fusing determined second point features; for each of the map elements, determine a second element feature of a corresponding map element, based on the BEV feature map, a first point feature of the corresponding map element, and coordinate information of each of a plurality of anchor points of the corresponding map element; and obtain the second element query by fusing determined second element features.

In the determining of the second point feature based on the BEV feature map, the first point feature, and the coordinate information of the corresponding anchor point, for each of the plurality of anchor points, the at least one processor may be further configured to: for each of the plurality of anchor points, determine a plurality of sampling points associated with the corresponding anchor point on the HD map, based on the coordinate information of the anchor point and the first point feature; obtain a third point feature through fusion based on the BEV feature map and coordinate information and a weight of each of the plurality of sampling points; and determine the second point feature based on the first point feature and the third point feature.

In the determining of the plurality of sampling points associated with the corresponding anchor point on the HD map, based on the coordinate information of the anchor point and the first point feature, for each of the plurality of anchor points, the at least one processor may be further configured to: determine a fourth point feature based on the coordinate information of the corresponding anchor point and the first point feature; determine a sampling offset and the weight of each of the plurality of sampling points based on the fourth point feature, wherein the sampling offset represents a degree of positional offset of a sampling point corresponding to the anchor point; and determine coordinate information of each of the plurality of sampling points, based on the coordinate information of the anchor point and the sampling offset of each of the plurality of sampling points.

In the electronic device, wherein a loss function used by the hybrid decoder during a training process comprises a point-element consistency loss, wherein the point-element consistency loss is used to represent a level of risk of inconsistency between a point query and an element query of the updated hybrid query.

### BRIEF DESCRIPTION OF THE DRAWINGS

FIG. 1 illustrates an example high-definition (HD) map.

FIG. 2 illustrates an example flow of a map construction method according to one or more embodiments.

FIG. 3 schematically illustrates an example map construction method according to one or more embodiments.

FIG. 4 illustrates an example system for a map construction method according to one or more embodiments.

FIG. 5 illustrates an example map construction method according to one or more embodiments.

FIG. 6 illustrates an example operational flow of a hybrid decoder according to one or more embodiments.

FIG. 7 illustrates an example operational flow of a hybrid decoder according to one or more embodiments.

FIG. 8 illustrates an example operation of updating a hybrid feature according to one or more embodiments.

FIG. 9 illustrates an example process of calculating a point-element consistency loss according to one or more embodiments.

FIG. 10 illustrates an example process of calculating a point-element consistency loss according to one or more embodiments.

FIG. 11 illustrates a comparison between a map construction method according to one or more embodiments and a related art method.

FIG. 12 illustrates an accuracy improvement effect of a map construction method according to one or more embodiments.

FIG. 13 illustrates an example electronic device with map construction according to one or more embodiments.

Throughout the drawings and the detailed description, unless otherwise described or provided, the same or like drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. As used herein, “connected to” or “coupled to” may also be construed as being “wirelessly connected to” or “wirelessly coupled to.” When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

At least some functions of an electronic device according to various embodiments may be implemented through an artificial intelligence (AI) model. For example, the AI model may be used to implement the electronic device or at least some modules among various modules of the electronic device. In this case, such functions associated with the AI model may be performed by a non-volatile memory, a volatile memory, or a processor.

The processor may include one or more processors. The one or more processors may be general-purpose processors (e.g., central processing units (CPUs), application processors (APs), etc.), graphics processing units (e.g., graphics processing units (GPUs), vision processing units (VPUs), etc.), AP-specific processors (e.g., neural processing units (NPUs), etc.), and/or combinations thereof.

The one or more processors may control processing input data according to predefined operational rules or AI models stored in the non-volatile memory and the volatile memory. The one or more processors may provide the predefined operational rules or AI models through training or learning.

In this case, such a learning-based provision may involve applying a learning algorithm to multiple pieces of training data to obtain the predefined operational rules or AI models with desired characteristics. In this case, training or learning may be performed on the device or electronic device itself on which an AI model is executed, and/or may be implemented by a separate server, device, or system.

An AI model may include layers of a neural network. Each layer may have weight values and perform a neural network computation by computations between input data of a current layer (e.g., a computational result from a previous layer and/or input data of the AI model) and a plurality of weight values of the current layer. The neural network may include, as non-limiting examples, a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q-network.

The learning algorithm may involve training a predetermined target device (e.g., a robot) using multiple pieces of training data to guide, allow, or control the target device to perform determination and estimation (or prediction). The learning algorithm may include, as non-limiting examples, supervised learning, unsupervised learning, semi-supervised learning, or reinforcement learning.

A method performed by an electronic device according to various embodiments may be applied to any of the following technical fields: speech, language, image, video, or data intelligence (or smart data).

For example, in the field of speech or language processing, the method performed by the electronic device may include a user speech recognition and user intent interpretation method that receives a speech signal, as an analog signal, via an audio acquisition device (e.g., a microphone) and converts the speech into a computer-readable text using an automatic speech recognition (ASR) model. The method may also interpret the text and analyze the intent of a user's utterance using a natural language understanding (NLU) model. The ASR model or NLU model may be an AI model. The AI model may be processed by a dedicated AI processor designed with a hardware architecture specified for processing the AI model. Here, language understanding is a technique for recognizing and applying/processing human language/text, such as, for example, natural language processing, machine translation, dialog systems, question answering, or speech recognition/synthesis.

For example, in the field of image or video processing, the method performed by the electronic device may include obtaining output data by using image data as input data for an AI model. The method performed by the electronic device may also relate to AI visual understanding, which is a technique for recognizing and processing objects in a way human visions do. It may include, for example, object recognition, object tracking, image retrieval, human recognition, scene recognition, three-dimensional (3D) reconstruction/positioning, or image enhancement.

For example, in the field of smart data processing, the method performed by the electronic device may perform prediction in an inference or prediction step using real-time input data using an AI model. A processor of the electronic device may preprocess the data and convert the data into a form suitable for use as an input to the AI model. An AI model may be used for inferential prediction, that is, making logical inferences and predictions based on determined information, and may include knowledge-based inference, optimized prediction, preference-based planning or recommendation, and the like.

The AI model may be processed by an AI-dedicated processor. This AI-dedicated processor may have a hardware structure specific for processing AI models. The AI model may be obtained by training an underlying AI model with multiple pieces of training data through a learning algorithm, such that the predefined operational rules or AI models configured to perform expected characteristics (or purposes) are obtained.

Hereinafter, technical approaches and effects will be described with various embodiments of the present disclosure. Unless there is no conflict or inconsistency, the embodiments may be referred to or combined with each other, and common terminology, and similar features and steps included in the embodiments will be described and will not be repeated if deemed redundant.

To construct a high-definition (HD) map, typical vectorized map construction algorithms such as MapTR and MapTRv2, are used to obtain a BEV space query (e.g., BEV features) through a map encoder and then to obtain a vectorized map element through a map decoder. The map decoder, which is a core module, may have input parameters that include a BEV feature and a point query, i.e., a parameter set represented by points of the map element, and output parameters that include an element category (e.g., a class) and point coordinates of the map element. However, these algorithms only use a point query representation, which may not be easy to completely represent the details of the map element by a limited number of points, thus degrading the accuracy of a constructed HD map.

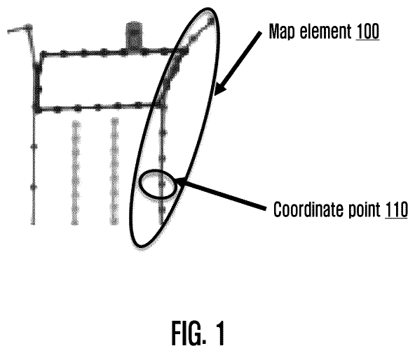

A HD map for autonomous driving may include map elements such as road shapes, road markings, traffic signs, and obstacles. FIG. 1 illustrates an example portion of a typical HD map. As shown in FIG. 1, the HD map may include a plurality of map elements 100, and each map element 100 may be represented by a set of coordinate points 110 on the HD map. The coordinate points 110 may be connected by multiple lines or polygons to represent a single semantic instance in the HD map. The coordinate points 110 may refer to points in a predefined coordinate system, which represent positions through coordinate information (e.g., point coordinates) in the predefined coordinate system. In a process of constructing the HD map, the plurality of coordinate points 110 are initially assigned to each of the map elements 100, but specific positions of the assigned coordinate points 110, i.e., the coordinate information of the assigned coordinate points 110, may be unknown. The coordinate information of the assigned coordinate points 110 may be continuously updated during an update process to be used to determine the respective specific positions of the assigned coordinate points 110. In the HD map, there are pixels, which are fixed points in an image, without being changed during the updating process described above. The map elements 100 may represent different semantics, and thus different element categories (also described as “classes” herein) may be formed for the map elements 100. The classes may include pedestrian crossings, lane dividers, road boundary lines, and the like, which may be used to represent the map elements 100 that may be different from each other. For example, as shown in FIG. 1, there are five map elements 100, which may include, in terms of element classes, two road boundary-related map elements (multiple dark-colored lines), two lane divider-related map elements (multiple light-colored lines), and one pedestrian crossing-related map element (a polygon).

The HD map may be classified as a local map and a global map based on time and distance. The local map may be a short-range map that may typically include data of a single frame. The data of a single frame may be single modality data such as a multi-view camera image (which may generally be a red, green, blue (RGB) image) or point cloud data obtained by a light detection and ranging (lidar) unit. The data of a single frame may also be multi-modality data including the camera image and the point cloud data, or multi-modality data including pose data for mapping different modality data into the same coordinate system, i.e., coordinate transformation information between the different modality data. The global map may be a long-range map that may typically include scene data in which a single scene is a sequence of multiple frames.

The typical HD map construction described herein, includes generating a set of vectorized static map elements based on original data (e.g., a camera image and point cloud data), as shown in FIG. 1. As the typical method for constructing an HD map uses only point query representation, it becomes difficult to represent the details of the map elements, lacks learning about the entire information (e.g., length, orientation, etc.) of each map element, and easily causes confusion and entanglement between different ones of the map elements, thereby degrading the accuracy of a constructed map.

To this end, provided herein is an HD map construction method that uses a hybrid query including a point query and an element query to describe point-level information and element-level information, respectively, and performs hybrid decoding on a bird's-eye view (BEV) feature map and the hybrid query to implement an interaction between the element-level information and the point-level information. This may thereby implement the complementary improvement and integration of the information to construct an HD map, and accordingly the constructed HD map may have a more complete shape and represent more accurate positions, with an enhanced map accuracy.

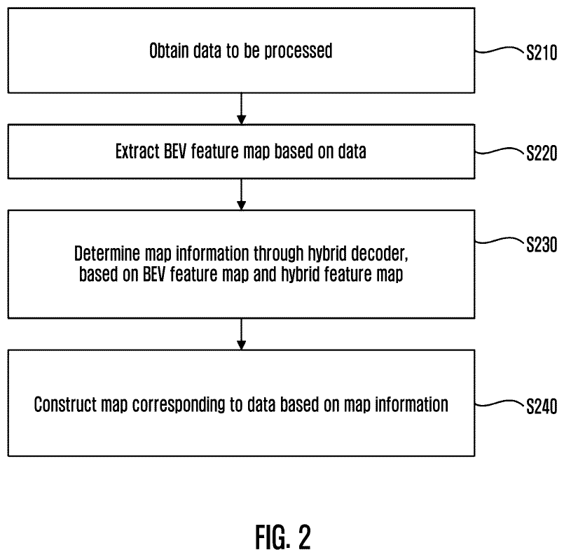

Hereinafter, methods, steps, or operations proposed in the present disclosure will be described in detail with reference to FIGS. 2 through 13.

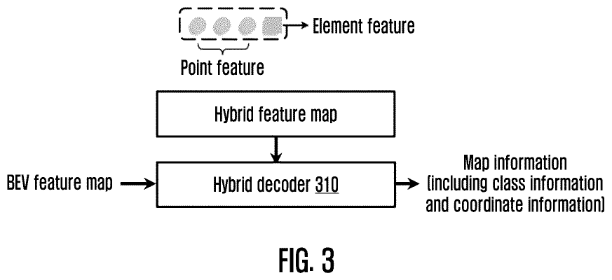

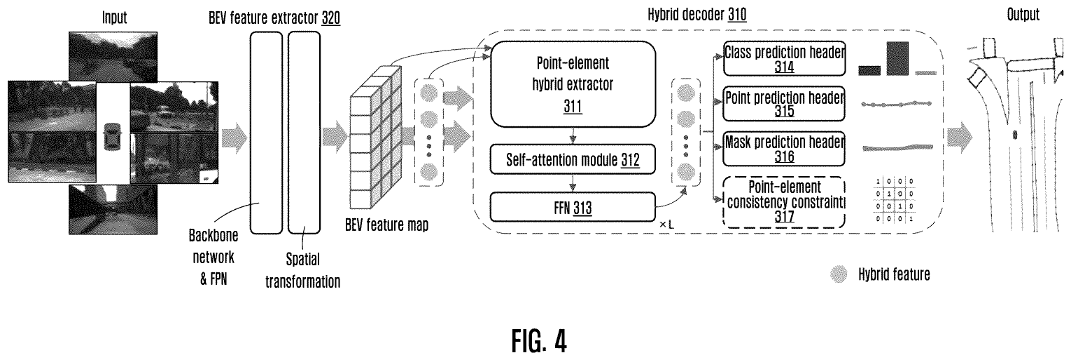

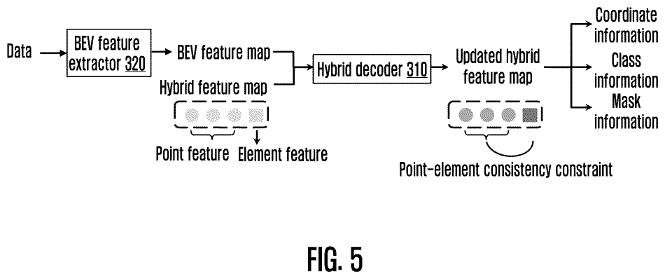

FIG. 2 illustrates an example flow of a map construction method according to one or more embodiments. FIG. 3 schematically illustrates an example map construction method according to one or more embodiments. FIG. 4 illustrates an example system for a map construction method according to one or more embodiments. FIG. 5 illustrates an example map construction method according to one or more embodiments.

Referring to FIGS. 2 and 5, in step S210, a plurality of sensor data is obtained as input/input data/input visual data.

The plurality of sensor data may be image data collected by at least one sensor (e.g., a camara) of an apparatus/electronic device and used to construct an HD map, as described above.

In step S220, a BEV feature map may be generated/extracted based on the sensor data.

In this step, a BEV feature extractor 320 (of FIG. 4) may be used to perform feature extraction on the sensor data obtained in step S210 by applying map construction operations/methods as shown in FIGS. 4 and 5.

For example, the BEV feature map may be a feature map in a BEV space. In a case where data to be used is a multi-view RGB image, a multi-scale two-dimensional (2D) feature may first be extracted from each viewing angle using a backbone network (e.g., a network such as Resnet, Swin Transformer, etc.), different scale features may then be fused using a feature pyramid network (FPN) to obtain a single-scale fused 2D feature map, and the fused 2D feature map may be transformed into a BEV feature map using a spatial transformation module (a technique for feature transformation from a 2D space to a BEV space). In a case where input visual data is a laser point cloud, a voxelized feature may be obtained using a single three-dimensional (3D) backbone network (e.g., SECOND), and the voxelized feature may then be flattened into the BEV feature map. In a case where data to be used is dual-modality (or dual-modal) data, BEV feature maps obtained from different modalities may be concatenated together, and a convolution operation may then be performed to obtain a single multi-modal fused BEV feature map.

In summary, for unimodal or multi-modal data, an output of the BEV feature extractor 320 may be a feature map X in the same space (e.g., the BEV space), where X is represented by a tensor of H*W*C, and H and W represent the height and width of an image represented by the data, respectively, and C represents the number of channels in the feature map. To learn a better BEV feature map, during a training process for the BEV feature extractor 320, a semantic segmentation loss may be used to supervise training.

In step S230, map information may be determined based on a hybrid decoder (e.g., a hybrid decoder 310 in FIG. 3) that uses, as an input, the BEV feature map and a hybrid query. In this case, the map information may include coordinate information of at least one coordinate point of each map element and class information of a class to which each map element belongs. The map information described herein may include information of each of a plurality of map elements. It is to be noted that the plurality of map elements may all be map elements being calculated or may be some map elements remaining after all the map elements have been filtered according to certain rules. In the following, the terms “respective” and “each” may be construed to have substantially the same meaning and will not be described in detail. A map may include a plurality of map elements, and each map element may include an area formed by a plurality of coordinate points in the map. The hybrid query may include a plurality of hybrid features, and each hybrid feature may include a point feature and an element feature corresponding to one map element. The point feature may be information associated with each coordinate point of the corresponding map element, and the element feature may be information associated with the corresponding map element.

The hybrid query, which may be shorted as HI query, may be a set of learnable parameters represented as Q^{h} ∈ [symbol] (where, “h” indicates the first letter of “hybrid”). Here, “E” may denote the maximum number of map elements (which is a predefined parameter) and may be set to any number that is sufficiently large to cover the required number of map elements. In addition, “P” may denote the maximum number of coordinate points of each map element, “1” may denote an element category (or class) to which a corresponding map element belongs, and “C” may denote the number of channels in the query. The description of the same symbols will not be repeated below. Each parameter Qᵢ^{h} ∈ [symbol] of the hybrid query may correspond to one map element, and i∈{1, . . . , E} may denote an index of a corresponding map element. Qᵢ^{h} may be decomposed into two parts—Qᵢ^{p} ∈ [symbol] which is a point query, where “p” denotes the first English letter of “point”) and Qᵢ^{e} ∈ [symbol] which is an element query, where “e” denotes the first English letter of “element”), which may represent point-level information and element-level information of an i-th map element, respectively. The hybrid query may have the point-level information and the element-level information, which are integrated therein, and may thus be used to generate map information including coordinate information (e.g., point coordinates), element class information, and mask information (obtained through three prediction headers, i.e., a class prediction header 314, a point prediction header 315 and a mask prediction header 316 as shown in FIGS. 4 through 6) for each map element. The hybrid query may be randomly initialized, i.e., obtained by assigning a random initial value to the hybrid query, and may then be gradually updated by interacting with the BEV feature map.

Optionally, step S230 may include: decomposing the hybrid query into a first point query and a first element query, respectively, wherein the first point query may include a first point feature corresponding to each coordinate point of each map element, and the first element query may include a first element feature corresponding to each map element; determining a second point query and a second element query, respectively, based on the BEV feature map, the first point query, the first element query, and current map information; updating the hybrid query by fusing the second point query and the second element query; and updating the map information based on the BEV feature map and the updated hybrid query, and performing a subsequent update by returning to the operation of decomposing the hybrid query into the first point query and the first element query. The current map information may refer to an interim state of map data during an HD map construction. The current map information may reflect estimated map element(s) based on the BEV feature map and an initial hybrid query. With each iteration/loop, the current map information may be refined and updated, ultimately converging into final map information used for a resulting HD map. By iteratively performing such a loop, continuous interaction and feature updates may be implemented to increase the accuracy of the hybrid query, and based on an end condition, to obtain finally updated map information (final map information). According to an embodiment, such an end condition may be set to end the loop, and the end condition may be to reach a set number of loops.

For example, for a Ith layer, the hybrid query Q^{h,i-1} ∈ (where the superscript “I−1” indicates that the hybrid query is a result of updating a I−1st layer) may be decomposed into two parts—an initial point query and an initial element query, using Equation 1 below.

$$[ {Q}^{p , t - 1} , {Q}^{e , l - 1} ] = {Q}^{h , t - 1} , \qquad ( 1 )$$

In Equation 1, [,] may denote a concatenation relationship, where the initial point query Q^{p,l-1} ∈ [symbol] and initial element query Q^{e,l-1} ∈ [symbol] are concatenated to form the initial hybrid feature Q^{h,l-1} ∈.

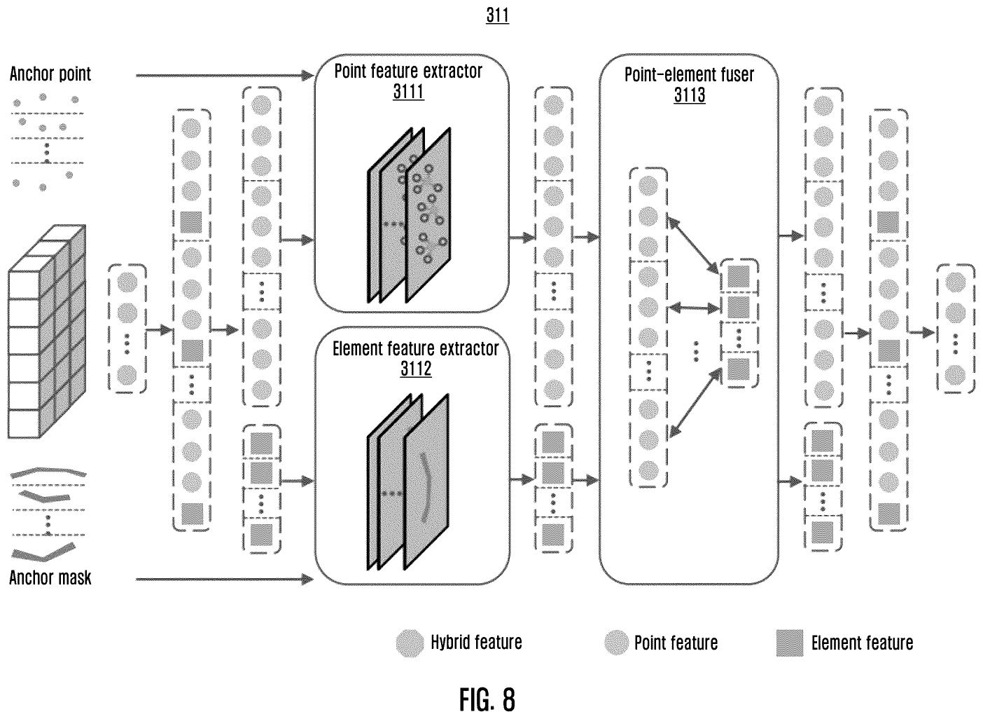

By decomposing a point feature and an element feature, the point feature and the element feature may interact with each other in subsequent interactions, and thus point-level information and element-level information of each map element may be extracted from the interactions and encoded into a new hybrid feature. In this case, the motivation behind the interaction between the point-level information and the element-level information may be complementarity. The point-level information may include knowledge about detailed local positions, while the element-level information may provide a global shape and semantic knowledge. Therefore, the interaction between the two pieces of level information may maximally utilize local information and global information to achieve mutual (or complementary) improvement and integration of the map information. Accordingly, as shown in FIG. 8, a point-element hybrid extractor 311 may include a point feature extractor 3111, an element feature extractor 3112, and a point-element fuser 3113.

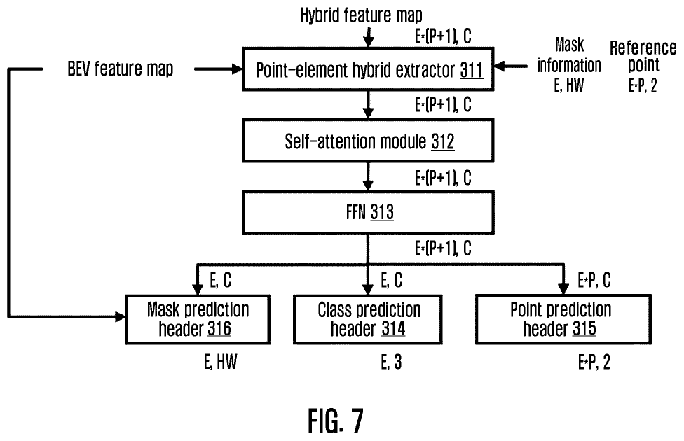

For example, as shown in FIGS. 4 and 7, the structure of a hybrid decoder 310 may include L layers, and each layer may include three modules: the point-element hybrid extractor 311, a self-attention module 312 (or a general-purpose computation module), and a feedforward network (FNN) 313 (or a general-purpose computation module). Each layer may iteratively and continuously update a hybrid feature. The updated hybrid feature may be input to three prediction headers, i.e., the point prediction header 314 (implemented by two linear layers), the category (or “class” herein) prediction header 315 (implemented by two linear layers), and the mask prediction header 316 (implemented by first passing through two linear layers and then multiplying an output result by a BEV feature map again to ensure that the size of obtained mask information is consistent with the BEV feature map), and accordingly coordinate information (e.g., point coordinates), element class information, and mask information of each map element may be generated. In this case, operations (or computations) of the three prediction headers 314, 315 and 316 may be independent of each other.

Hereinafter, a detailed processing process of each loop will be described.

The map information may include coordinate information of coordinate points. The operation of determining the second point query and the second element query, respectively, based on the BEV feature map, the first point query, the first element query, and the current map information may include: for each of a plurality of anchor points, determining a second point feature of a corresponding anchor point based on the BEV feature map, a first point feature of the anchor point, and coordinate information of the anchor point, wherein the anchor point may include a coordinate point corresponding to each first point query; and obtaining the second point query by fusing the obtained second point features. Each of the anchor points may refer to a learnable 2D point designed to effectively extract point-level features near a map element. As a reference point for sampling, an anchor point allows for a precise extraction of features of the map element. The current map information may include the coordinate information of each anchor point that is extracted from the map information. When determining the second point query, it may be important to sample an anchor point (i.e., a target coordinate point) and make it close to a corresponding map element to which the anchor point belongs. The anchor point may be randomly given initially as a coordinate point to be learned (e.g., the anchor point described above), and continuously updating it to a learnable parameter through iterations may enable the effective extraction of a point feature. It is to be noted that, when initializing an initial hybrid query, an anchor point in a first loop may be a coordinate point randomly determined for each map element, and the anchor point in a subsequent loop may be a coordinate point of the map element updated in the previous loop.

The operation of determining, for each of the plurality of anchor points, the second point feature based on the BEV feature map, the first point feature, and the coordinate information of the corresponding anchor point may include: for each of the plurality of anchor points, determining a plurality of sampling points associated with the corresponding anchor point on the map based on the coordinate information of the anchor point and the first point feature; obtaining a third point feature through fusion, which is performed based on the BEV feature map and coordinate information and a weight of each of the plurality of sampling points; and determining the second point feature based on the first point feature and the third point feature. By comprehensively calculating a fused point feature by concatenating a plurality of sampling points around each anchor point and superimposing the fused point feature on a feature of each anchor point, a local point feature of each anchor point may be obtained. Subsequently, by superimposing a global point feature (e.g., the point feature of the point query decomposed from the hybrid query) on the local point feature, an interaction between each anchor point and its surrounding sampling points may be implemented, thereby obtaining a reliable output point feature.

The operation of determining, for each anchor point, the plurality of sampling points associated with the corresponding anchor point in the map based on the coordinate information of the corresponding anchor point and the first point feature may include: for each anchor point, determining a fourth point feature based on the coordinate information of the corresponding anchor point and the first point feature, wherein the fourth point feature may be used to represent a point feature after considering the influence of the coordinate information; determining sampling offsets and weights of the plurality of sampling points associated with the anchor point based on the fourth point feature, wherein a sampling offset may be used to represent a degree of positional offset of a sampling point relative to the anchor point; and determining coordinate information of each sampling point of the anchor point based on the coordinate information of the anchor point and the sampling offset of each sampling point. By concatenating the coordinate information of the anchor point and the first point feature and determining the fourth point feature, and then determining the sampling offset and the weight of a sampling point, the sampling point associated with the anchor point may be obtained. In this case, a reliable sampling point may thus be determined.

The operation of determining the fourth point feature based on the coordinate information of the anchor point and the first point feature may include: obtaining a position embedding of the anchor point by encoding the coordinate information of the anchor point; and determining the fourth point feature based on the first point feature and the position embedding. By superimposing the position embedding of the anchor point on the first point feature, the coordinate information of the anchor point may be further integrated, which may improve a feature representation capability.

The operation of obtaining the third point feature through the fusion based on the BEV feature map and the coordinate information and the weight of each sampling point associated with the anchor point may include: determining a sampling feature of the anchor point corresponding to each sampling point based on the BEV feature map and the coordinate information of each sampling point associated with the anchor point; and obtaining the third point feature by fusing determined sampling features of the anchor point respectively corresponding to the sampling points, based on the weight of each sampling point associated with the anchor point. By first allowing a sampling point to interact with the BEV feature map and obtaining the sampling feature, and then performing the fusion, for example, weighted summation, on the sampling features of the sampling points, each reliable third point feature may be calculated. Accordingly, the fusion may be implemented, which may be conducive to calculating the second point feature.

In summary, the second point query \dot{X}^{p,l} ∈ [symbol] may be obtained using the point feature extractor 3111 (of FIG. 8), and a detailed process of this may be represented by Equations 2, 3, and 4 below. First, the fourth point feature \hat{Q}ⱼ^{p,l} ∈ [symbol] may be generated using Equation 2 below.

$${B}_{j}^{p , l} = {W}_{b} ( {P}_{j}^{l - 1} ) , \qquad ( 2 )$$

$${\hat{Q}}_{j}^{p , l} = {Q}_{j}^{p , l - 1} + {B}_{j}^{p , l} ,$$

In Equation 2, P^{l-1} ∈ [symbol] may denote a point coordinate output from a previous layer, which may be used as an anchor point in a current layer. The subscript “j” may denote a specific anchor point (i.e., j∈{1, . . . , E×P}), and [symbol] may denote a two-dimensional (2D) point. A point feature output from the [symbol] previous layer may be used as a C-dimensional vector, which is a first point feature of the current layer. W_{b} ∈ [symbol] may denote a learnable parameter of a linear layer, and Bⱼ^{p,l} ∈ [symbol] may denote a position embedding of the anchor point.

Subsequently, each anchor point may be sampled into K points, and then a sampling offset ΔPⱼ^{l} ∈ [symbol] and a weight Aⱼ^{l} ∈ [symbol] of the sampling points may be generated using Equation 3 below.

$$Δ {P}_{j}^{l} = {W}_{o} ( {\hat{Q}}_{j}^{p , l} ) , \qquad ( 3 )$$

$${A}_{j}^{l} = softmax ( {W}_{a} ( {\hat{Q}}_{j}^{p , l} ) ) ,$$

In Equation 3, Wₐ ∈ [symbol] , Wₐ ∈ [symbol] may all be a learnable parameter of the linear layer, and a softmax operation may be performed on the dimensionality of the sampling points.

Lastly, the second point feature \dot{X}^{p,l} ∈ [symbol] may be obtained using Equation 4 below.

$${V}_{x}^{p} = {W}_{v} ( X ) , \qquad ( 4 )$$

$${X}_{j}^{p , l} = {\sum }_{k = 1}^{K} {A}_{j , k}^{l} \cdot {V}_{x}^{p} ( {P}_{j}^{l - 1} + Δ {P}_{j , k}^{l} ) ,$$

$${\dot{X}}_{j}^{p , l} = {X}_{j}^{p , l} + {Q}_{j}^{p , l - 1} ,$$

In Equation 4, Wᵥ∈R^{C×C} may denote a learnable parameter of one linear layer, Vₓ^{p} may denote a transformed BEV feature map, and ΔP_{j,k}^{l} ∈R² may denote a 2D point (where, k denotes an index between 1 and K) representing a sampling offset of a sampling point. A_{j,k}^{l} may denote a weight with a value between 0 and 1 that satisfies a normalization condition for Σₖ₌₁^{K} A_{j,k}^{l}=1 Vₓ^{p}(Pⱼ^{l-1}+ΔP_{j,k}^{l}) may denote a sampling feature of each sampling point, and Xⱼ^{p,l} ∈ [symbol] may denote a first point feature obtained by fusing features of the K sampling points of the anchor point (where, “j” denotes an index). \dot{X}ⱼ^{p,l} ∈ [symbol] may denote a second point feature corresponding to one anchor point. A sum of second point features of all the anchor points may correspond to the second point query \dot{X}^{p,l} ∈ [symbol] of the current layer. During the calculation process, a point coordinate is a floating-point value, and thus bilinear interpolation may be used for sampling in the map Vₓ^{p}.

Optionally, the map information may include coordinate information of coordinate points. The operation of determining the second point query and the second element query, respectively, based on the BEV feature map, the first point query, the first element query, and the current map information may further include: for each map element, determining a second element feature of a corresponding map element based on the BEV feature map, a first element feature of the map element, and coordinate information of each anchor point of the map element; and obtaining the second element query by fusing the determined second element features of respective map elements. The coordinate information of the map element may be directly related to coordinate information of each coordinate point of the map element, and the coordinate information of each anchor point of the map element may be used to update an interaction with the first element feature. Thus, a correlation between the coordinate points and the map element is improved, and a more accurate output element feature is obtained.

Optionally, the operation of determining, for each map element, the second element feature of the map element based on the BEV feature map, the first element feature of the map element, and the coordinate information of each anchor point of the map element may include: for each map element, obtaining a position embedding of each anchor point by encoding the coordinate information of each anchor point of the map element; obtaining a position embedding of the map element by fusing the obtained position embeddings of respective anchor points of the map element; and determining the second element feature of the map element by using a masked-attention module in the hybrid decoder (e.g., the hybrid decoder 310 of FIG. 4), based on the BEV feature map, the first element feature of the map element, and the position embedding of the map element. In this case, a mask used in the masked-attention module may be obtained based on mask information of each pixel, and the mask information may be used to represent a probability that a corresponding pixel belongs to the map element. According to an embodiment of the present disclosure, the masked-attention module may be used to extract the second element feature. By fusing the position embedding of each anchor point of the map element with the position embedding of the map element, the position embedding of the map element and the position embedding of each anchor point may be correlated to improve the correlation between the coordinate points and the map element. As described above, an anchor point may include a learnable coordinate point, i.e., a learnable parameter, and similarly, an anchor mask may include a learnable parameter. An initial value of the anchor mask may be randomly given, as shown in FIG. 8.

In summary, the second element query \dot{X}^{e,l} ∈ [symbol] may be obtained using the element feature extractor 3112 (of FIG. 8), and a detailed process of this may be represented by Equations 5 and 6 below. First, a position-aware element feature \hat{Q}ᵢ^{e,l} ∈ [symbol] and a position-aware BEV feature map \hat{X} ∈ [symbol] may be generated using Equation 5 below.

$${\hat{Q}}_{i}^{e , l} = {Q}_{i}^{e , l - 1} + {B}_{i}^{e , l} , \qquad ( 5 )$$

$$\hat{X} = X + {B}^{x , l} ,$$

In Equation 5, Qᵢ^{e,l-1} ∈ [symbol] may denote an element feature of an ith map element (where, “i” may be in a range 1 to E and be used for indexing a specific map element), and Bᵢ^{e,l} may denote a position embedding generated for the map element (which may be obtained by directly using a previously obtained position embedding Bⱼ^{p,l} ∈ [symbol] of an anchor point, assigning a weight to position embeddings of all anchor points belonging to one map element, and summing (e.g., averaging) them.) B^{x,l} ∈ [symbol] may denote a position embedding corresponding to the BEV feature map, which may be obtained by using a position coding technique according to the related art to superimpose it on the BEV feature map X and calculate a sum of the two to obtain the position-aware BEV feature map \hat{X} ∈

[symbol]

Subsequently, the second element query \dot{X}^{e,l} ∈ [symbol] may be generated using Equation 6 below.

$${X}_{i}^{e , l} = ( {M}^{l - 1} \cdot softmax ( {\hat{Q}}_{i}^{e , l} \hat{{X}^{T}} ) ) X , \qquad ( 6 )$$

$${\dot{X}}_{i}^{e , l} = {X}_{i}^{e , l} + {Q}_{i}^{e , l - 1} ,$$

In Equation 6, M^{l-1} ∈{0, 1}^{HW} may denote a binary mask map obtained by binarizing mask information output from a I−1st layer (where, a binarization threshold value is 0.5), and Xᵢ^{e,l}=(M^{l-1}·softmax(\hat{Q}ᵢ^{e,l}\hat{X}^{T}))X may denote an extracted element feature of the map element (where, “i” denotes an index). \dot{X}ᵢ^{e,l} ∈ [symbol] obtained from Equation 6 may denote a local output element feature corresponding to one map element. A sum of second element features of all map elements may be the second element query \dot{X}^{e,l} ∈ [symbol] of the current layer.

For example, fusing the second point query and the second element query may include fusing twice an output point feature and an output element feature. As shown in FIG. 7, a first fusion may be performed by the point-element hybrid extractor 311. After a first fused feature is obtained by the first fusion, the fused feature may be input to the self-attention module 312 and the FFN 313. On the first fused feature, two steps (a self-attention module step and an FFN step) may be successively performed, and then a finally obtained feature therefrom may be used as an output hybrid feature of a current loop.

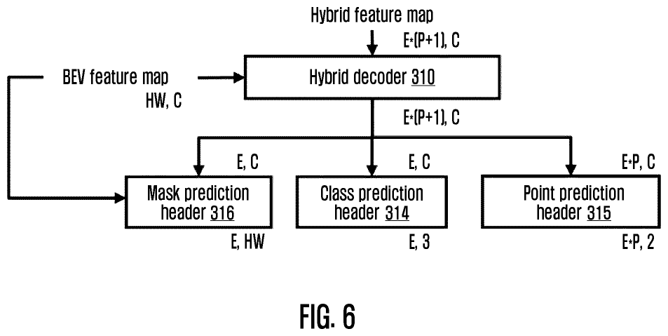

Optionally, the first fusion may include: obtaining a fifth point query and a fifth element query by processing the second point query and the second element query, respectively, using the self-attention module (e.g., the self-attention module 312 of FIG. 7) in the hybrid decoder (e.g., the hybrid decoder 310 of FIG. 6); obtaining a sixth element query by transforming the fifth point query into the same dimension as the fifth element query and fusing the fifth element query and the transformed fifth point query; obtaining a sixth point query by transforming the fifth element query into the same dimension as the fifth point query and fusing the fifth point query and the transformed fifth element query; and obtaining an updated hybrid feature query by fusing the sixth point query and the sixth element query. By performing an intra-level interaction on the second point query and the second element query, respectively, using a self-attention module (different from the self-attention module 312) of the point-element hybrid extractor 311 and then performing a cross-level interaction through dimension transformation and fusion in the form of merging, and encoding results of the interactions into the updated hybrid feature query, a complete fusion between the second point query and the second element query may be implemented, and the purpose of updating the hybrid feature query may be achieved.

For example, the intra-level interaction performed by the self-attention module may be implemented by Equation 7 below.

$${\ddot{X}}^{p , l} = {ℱ}_{rp} ( {\dot{X}}^{p , l} ) , \qquad ( 7 )$$

$${\ddot{X}}^{e , l} = {ℱ}_{re} ( {\dot{X}}^{e , l} ) ,$$

In Equation 7, [symbol] rp and [symbol] re may denote a point-level interaction and an element-level interaction, respectively. In this example, these two may be implemented by a general self-attention module and a feedforward network (FNN) of the point-element hybrid extractor 311.

The cross-level interaction may be implemented by Equation 8 below.

$${Q}_{j}^{p , l} = {\ddot{X}}^{p , l} + {ℱ}_{ce} ( {\ddot{X}}^{e , l} ) , \qquad ( 8 )$$

$${Q}_{j}^{e , l} = {\ddot{X}}^{e , l} + {ℱ}_{cp} ( {\ddot{X}}^{p , l} ) ,$$

In Equation 8, [symbol] ce may be to copy P pieces of information from the fifth element query and concatenate them to match it to a dimension [symbol] of the fifth point query, and [symbol] cp may be to assign a weight to the fifth point query of P anchor points belonging to the same map element, and calculate a sum of them, to match a result therefrom to a dimension [symbol] of the fifth element query.

Equation 8 may be used to obtain an updated sixth point query Q^{p,l} ∈ [symbol] and an updated sixth element query Q^{e,l} ∈ [symbol] , and concatenate them to obtain the updated hybrid query Q^{h,l} ∈x [symbol] . The details may be represented by Equation 9 below.

$${Q}^{h , l} = [ {Q}^{p , l} , {Q}^{e , l} ] , \qquad ( 9 )$$

Referring back to FIG. 2, in step S240, a map corresponding to the data may be constructed based on the map information. In this step, the map corresponding to the data may be constructed based on the final map information determined in step S230.

As described above, at the end of each loop, a prediction header may be used to obtain map information corresponding to an updated hybrid query, and map information obtained in the last loop may be directly used in that step. For example, the class prediction header (e.g., the class prediction header 314 of FIG. 4) may output class information about a class to which each map element belongs and its confidence, configure a confidence threshold value, and, in response to a confidence corresponding to a specific map element being less than the confidence threshold value, discard the map element. Similarly, the point prediction header (e.g., the point prediction header 315 of FIG. 4) may output coordinate information of coordinate points of each map element and its confidence, configure a confidence threshold value (which may be the same as or different from the confidence threshold value of the element class information), and, in response to a confidence corresponding to a specific coordinate point being less than the confidence threshold value, discard the coordinate point, i.e., not use the coordinate point as an anchor point.

Further, a loss function used by the hybrid decoder (e.g., the hybrid decoder 310 of FIG. 4) during the training process may include a point-element consistency loss. The point-element consistency loss may be used to indicate a degree of risk of inconsistency between a point query and an element query of an updated hybrid query. It is to be noted that the degree of risk may refer to the magnitude of the risk, and the point-element consistency loss may be a level, a probability, or any other reasonable form of value, but examples of which are not limited thereto. Based on an intrinsic difference between a point-level feature that focuses on local information and an element-level feature that focuses on global information, learning the two level features may also interfere with each other, which may increase the difficulty of information interaction and reduce the effectiveness of information interaction. By introducing the point-element consistency loss, a point-element consistency constraint 317 (of FIG. 4) may be implemented to improve the consistency between the point-level information and the element-level information of each map element and strengthen the distinguishability of map elements. Therefore, the entanglement between different map elements can be reduced, thereby improving the accuracy of a constructed map.

A value of the point-element consistency loss may be determined by the following method: obtaining the point-level information and the element-level information by transforming the point query and the element query of the updated hybrid query, respectively; obtaining pseudo-element-level information by fusing information of coordinate points belonging to the same map element in the point-level information; and determining the value of the point-element consistency loss based on the pseudo-element-level information and the element-level information to represent a degree of risk of inconsistency between the pseudo-element-level information and the element-level information. By fusing the point-level information based on the map element to which the point-level information belongs, the pseudo-element-level information that is dimensionally consistent with the element-level information and that reflects the point-level information may be obtained. By comparing the pseudo-element-level information and the element-level information and determining the value of the point-element consistency loss, a reliable calculation of the point-element consistency loss is implemented. For example, when determining the pseudo-element-level information, all coordinate points of the same map element may be used, or some of the coordinate points may be used. Examples thereof are not limited to the preceding example.

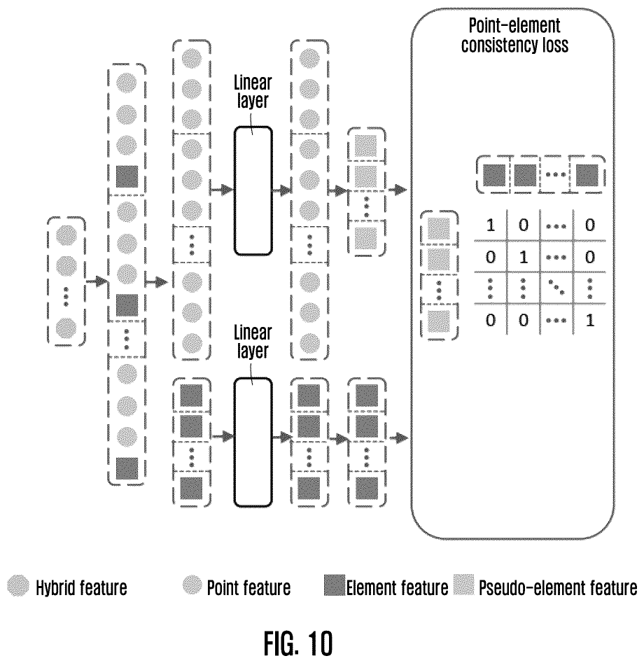

For example, a condition of the point-element consistency constraint 317 (of FIG. 4) may be defined for intermediate results of the point prediction header 315 (of FIG. 4) and the mask prediction header 316 (of FIG. 4). For example, input data may include a point-level feature Q^{p,l} ∈ [symbol] and an element-level feature Q^{e,l} ∈ [symbol] , which are obtained by decomposing a hybrid feature. In this case, a process to be performed is as shown in FIG. 10. After extracting the point-level feature and the element-level feature from the hybrid feature, the two may be transformed as represented by Equation 10 below.

$${\overline{Q}}^{p , l} = {W}_{p} ( {Q}^{p , l} ) , \qquad ( 10 )$$

$${\overline{Q}}^{e , l} = {W}_{m} ( {Q}^{e , l} ) ,$$

In Equation 10, Wₚ and Wₘ may denote all learnable parameters of a linear layer. Q̅^{p,l} ∈ [symbol] and Q̅^{e,l} ∈ [symbol] may be the transformed point-level information and the transformed element-level information, respectively, to which the linear layers of the point prediction header 315 (of FIG. 4) and the mask prediction header 316 (of FIG. 4) are applied, respectively.

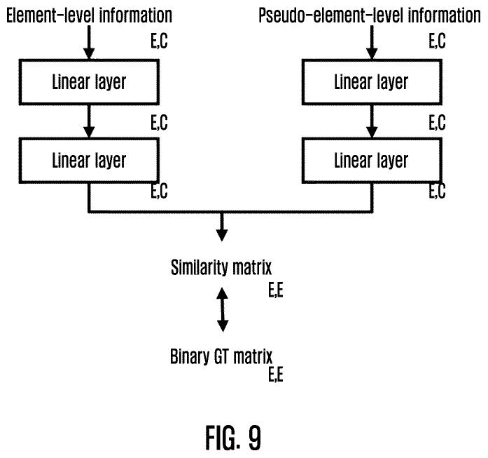

Subsequently, in Q̅^{p,l}, weights may be assigned to point-level information of all coordinate points belonging to the same map element and summed to obtain one pseudo-element-level representation \tilde{Q}^{e,l} ∈ [symbol] . Subsequently, an element similarity matrix A^{e,l} ∈ [symbol] may be calculated using Equation 11, as shown in FIG. 9.

$${A}^{e , l} - {\tilde{Q}}^{e , l} {( {\overline{Q}}^{e , l} )}^{T} , \qquad ( 11 )$$

Subsequently, a binary cross-entropy loss may be applied between the calculated similarity matrix and a binary ground truth (GT) correspondence matrix, and “1” may be assigned to a diagonal entry corresponding to the same element and zero “0” may be assigned to a different element. By promoting a high similarity between the pseudo-element-level information and the element-level information, the consistency between the point-level information and the element-level information is improved, and the consistency between the point-level feature and the element-level feature of the output hybrid feature is also improved.

Optionally, the loss function used by the hybrid decoder (e.g., the hybrid decoder 310) during the training process may further include at least one of a classification loss (for supervising the class prediction header (e.g., the class prediction header 314), a focal loss function may be used), a point regression loss (for supervising the point prediction header, an L1 loss function may be used), a point orientation loss (for supervising the point prediction header, the L1 loss function may be used), or a mask loss (for supervising the mask prediction header (e.g., the mask prediction header 316), a binary cross-entropy function and a dice function may be used). The preceding configurations of the loss function may provide a reference for training the corresponding structures in the hybrid decoder. A weight of each loss function may be configured as desired.

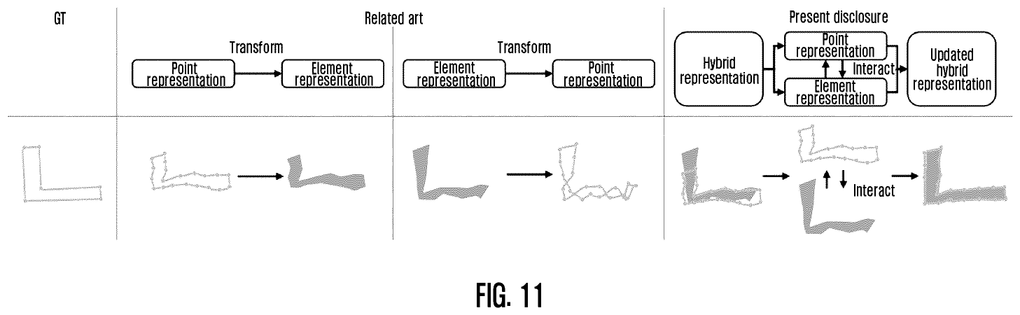

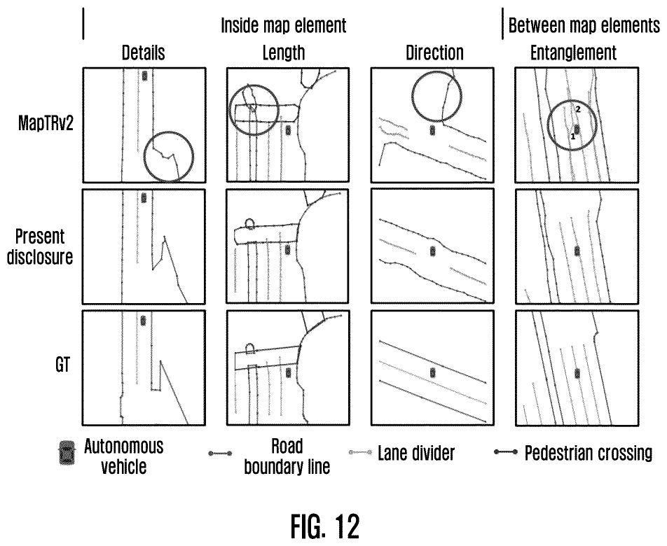

As shown in FIGS. 11 and 12, according to the related art, there may be a lack of interaction between two pieces of level information, which may readily lead to incomplete shapes at an element level or inaccurate positions at a point level. However, according to the present disclosure, point-level and element-level hybrid representation and interaction may provide more complete shapes and more accurate positions, and thus richer details and more accurate map element shapes may be generated, with entanglement between map elements reduced.

An aspect of embodiments of the present disclosure may further provide an electronic device. The electronic device may include at least one processor and, optionally, may further include at least one transceiver and/or at least one memory connected to the at least one processor. The at least one processor may be configured to execute the steps or operations of the methods described herein according to any optional embodiments of the present disclosure.

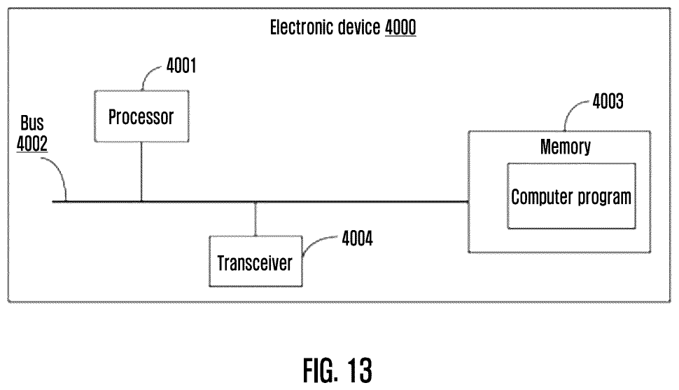

FIG. 13 illustrates an example electronic device according to one or more embodiments. As shown in FIG. 13, an electronic device 4000 may include a processor 4001 and a memory 4003. The processor 4001 and the memory 4003 may be coupled, and may be connected via a bus 4002, for example. Optionally, the electronic device 4000 may further include a transceiver 4004, and the transceiver 4004 may be used for data exchange such as data transmission and/or data reception between that electronic device 4000 and another electronic device. It is to be noted that, in practical applications, the number of each of the processor 4001, the memory 4003, and the transceiver 4004 is not limited to one, and the structure of the electronic device 4000 is not necessarily limited thereto. Optionally, the electronic device 4000 may be a first network node, a second network node, or a third network node.

The processor 4001 may be, as non-limiting examples, a central processing unit (CPU), a general-purpose processor, a digital signal processor (DSP), an application-specific integrated circuit (ASIC), a field-programmable gate array (FPGA) or any other programmable logic device, a transistor logic device, a hardware component, or any combination thereof. It may implement or execute various example logic blocks, modules, and circuits described herein. The processor 4001 may also be a combination that implements computing functionality, including, for example, a combination of one or more microprocessors, a combination of a DSP and a microprocessor, and the like.

The bus 4002 may include a path for transferring information between the components described above. The bus 4002 may be a peripheral component interconnect (PCI) bus or an extended industry standard architecture (EISA) bus. The bus 4002 may be classified into an address bus, a data bus, a control bus, or the like. For illustrative purposes, only one bold line is shown in FIG. 13, but there is not necessarily only one bus or only one type of bus.

The memory 4003 may be, as non-limiting examples, a read-only memory (ROM) or other types of static storage device capable of storing static information and instructions, a random-access memory (RAM) or other types of dynamic storage device capable of storing information and instructions, an electrically erasable programmable read-only memory (EEPROM), a compact disc ROM (CD-ROM) or other optical disc storage, an optical disc storage (e.g., a compressed optical disc, a laser disc, an optical disc, a digital versatile disc, a Blu-ray disc, etc.), a disk storage medium, other magnetic storage device, or any other computer-readable medium that may be used to carry or store computer programs.

The memory 4003 may be used to store computer programs or executable instructions for executing embodiments of the present disclosure and may be controlled by processor 4001. The processor 4001 may be configured to execute the computer programs or executable instructions stored in the memory 4003 to implement the steps or operations of the methods described herein according to the embodiments of the present disclosure.

The method described herein may provide hybrid learning that enables interaction between point-level information and element-level information. For example, according to an embodiment, a hybrid feature, and a simple and effective hybrid framework may be used. The hybrid feature may be a set of learnable parameters that represent all map elements in a map. It may be iteratively updated and improved through an interaction with a BEV feature map. During such an iterative process, both the point-level information and the element-level information of a map element may be integrated and encoded into the hybrid query. Each hybrid feature of the hybrid query may correspond to one separate map element, which may be directly transformed into coordinate information (e.g., point coordinates), element class information, and mask information of the corresponding map element. As an example, a difference between this method and the typical method is shown in FIG. 11. A map element obtained by the method described herein through the point-level and element-level hybrid representation and interaction may have a more complete shape and a more accurate position, greatly outperforming the accuracy of the typical method of the related art. Further, the present disclosure introduces a condition of a point-element consistency constraint (e.g., the point-element consistency constraint 317 in FIG. 4) to achieve consistency between the two pieces of level information, which may reduce the entanglement between map elements.

The embodiments of the present disclosure may provide a computer-readable storage medium on which a computer program or instructions are stored, and when the computer program or instructions are executed by at least one processor, the steps and operations of the methods described herein may be implemented.

The embodiments of the present disclosure may also provide a computer program product including the computer program that, when executed by the processor, implements the steps and operations of the methods described herein.

The terms used herein, such as, “first,” “second,” “third,” “fourth,” “initial (ly),” “subsequent (ly),” and the like, may not be used to define an essence, order, or sequence of the steps or operations of the methods described herein but may be used only to distinguish the steps or operations of the methods. For example, the sequences of operations described herein are merely examples, and are not limited to those set forth herein, but may be changed as will be apparent after an understanding of the disclosure of this application, with the exception of operations necessarily occurring in a certain order.

In the flowcharts illustrated in connection with the embodiments of the present disclosure, steps or operations are indicated along with arrows. However, it should be understood that the order of execution of these steps or operations is not limited to the order indicated by the arrows. Unless explicitly stated herein, in some implementation scenarios of embodiments of the present disclosure, the steps or operations may be executed in a different order depending on requirements. Further, some or all of the steps or operations described with reference to each flowchart may include multiple sub-steps or sub-operations according to actual implementation scenarios. Some or all of these sub-steps or sub-operations may be executed simultaneously or at different times. In scenarios with different execution times, the order of execution of these sub-steps or sub-operations may be flexibly configured according to requirements, and embodiments of the present disclosure are not limited thereto.

The electronic devices, the processors, the memories, and other apparatuses, devices, units, modules, and components described herein with respect to FIGS. 1-13 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-13

that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method with map construction, comprising:
extracting a bird's-eye view (BEV) feature map based on input data;
determining map information through a hybrid decoder based on the BEV feature map and a hybrid query; and
constructing a high-definition (HD) map corresponding to the input data based on the map information,
wherein the HD map comprises a plurality of map elements,
wherein the map information comprises coordinate information and class information of the plurality of map elements,
wherein each of the plurality of map elements comprises an area formed by a plurality of coordinate points in the HD map,
wherein the hybrid query comprises a plurality of hybrid features,
wherein each of the plurality of hybrid features comprises a point feature and an element feature corresponding to a map element,
wherein the point feature represents information associated with each coordinate point of the map element, and
wherein the element feature represents information associated with the map element.

2. The method of claim 1, wherein the determining of the map information through the hybrid decoder based on the BEV feature map and the hybrid query comprises:
decomposing the hybrid query into a first point query and a first element query, wherein the first point query comprises a first point feature corresponding to each coordinate point of each map element, and the first element query comprises a first element feature corresponding to each map element;
determining a second point query and a second element query, based on the BEV feature map, the first point query, the first element query, and current map information;
updating the hybrid query by fusing the second point query and the second element query; and
iteratively updating the current map information based on the BEV feature map and the updated hybrid query to generate final map information,
wherein the constructing of the HD map corresponding to the input data based on the map information comprises:
constructing the HD map corresponding to the input data based on the final map information.

3. The method of claim 2, wherein the determining of the second point query and the second element query, based on the BEV feature map, the first point query, the first element query, and the current map information comprises:
for each of a plurality of anchor points, determining a second point feature based on the BEV feature map, the first point feature, and coordinate information of a corresponding anchor point, wherein the corresponding anchor point comprises a coordinate point corresponding to the first point feature;
obtaining the second point query by fusing determined second point features;
for each of the map elements, determining a second element feature of a corresponding map element, based on the BEV feature map, a first point feature of the corresponding map element, and coordinate information of each of a plurality of anchor points of the corresponding map element; and
obtaining the second element query by fusing determined second element features.

4. The method of claim 3, wherein the determining of the second point feature based on the BEV feature map, the first point feature, and the coordinate information of the corresponding anchor point, for each of the plurality of anchor points, comprises:
for each of the plurality of anchor points, determining a plurality of sampling points associated with the corresponding anchor point on the HD map, based on the coordinate information of the anchor point and the first point feature;
obtaining a third point feature through fusion based on the BEV feature map and coordinate information and a weight of each of the plurality of sampling points; and
determining the second point feature based on the first point feature and the third point feature.

5. The method of claim 4, wherein the determining of the plurality of sampling points associated with the corresponding anchor point on the HD map, based on the coordinate information of the anchor point and the first point feature, for each of the plurality of anchor points, comprises:
determining a fourth point feature based on the coordinate information of the corresponding anchor point and the first point feature;
determining a sampling offset and the weight of each of the plurality of sampling points based on the fourth point feature, wherein the sampling offset represents a degree of positional offset of a sampling point corresponding to the anchor point; and
determining coordinate information of each of the plurality of sampling points, based on the coordinate information of the anchor point and the sampling offset of each of the plurality of sampling points.

6. The method of claim 5, wherein the determining of the fourth point feature based on the coordinate information of the corresponding anchor point and the first point feature comprises:
obtaining a position embedding by encoding the coordinate information of the corresponding anchor point; and
determining the fourth point feature, based on the first point feature and the position embedding.

7. The method of claim 4, wherein the obtaining of the third point feature through the fusion based on the BEV feature map and the coordinate information and the weight of each of the plurality of sampling points comprises:
determining a sampling feature corresponding to each of the plurality of sampling points, based on the BEV feature map and the coordinate information of each of the plurality of sampling points; and
obtaining the third point feature by fusing determined sampling features respectively corresponding to the plurality of sampling points, based on the weight of each of the plurality of sampling points.

8. The method of claim 3, wherein the determining of the second element feature of the corresponding map element based on the BEV feature map, the first element feature of the corresponding map element, and the coordinate information of each of the plurality of anchor points of the corresponding map element, for each of the map elements, comprises:
for each of the map elements, obtaining a position embedding of each of the plurality of anchor points by encoding the coordinate information of each of the plurality of anchor points;
obtaining a position embedding of the corresponding map element by fusing obtained respective position embeddings of the plurality of anchor points; and
determining the second element feature of the corresponding map element, using a masked-attention module of the hybrid decoder, based on the BEV feature map, the first element feature, and the position embedding of the corresponding map element,
wherein a mask of the masked-attention module is obtained based on mask information of each pixel,
wherein the mask information represents a probability that each pixel belongs to the corresponding map element.

9. The method of claim 2, wherein the iteratively updating of the hybrid query by fusing the second point query and the second element query comprises:
obtaining a fifth point query and a fifth element query by processing the second point query and the second element query, respectively, using a self-attention module of the hybrid decoder;
obtaining a sixth element query by transforming the fifth point query into the same dimension as the fifth element query and fusing the fifth element query and the transformed fifth point query;
obtaining a sixth point query by transforming the fifth element query into the same dimension as the fifth point query and fusing the fifth point query and the transformed fifth element query; and
obtaining the updated hybrid query by fusing the sixth point query and the sixth element query.

10. The method of claim 1, wherein a loss function used by the hybrid decoder during a training process comprises a point-element consistency loss,
wherein the point-element consistency loss is used to represent a level of risk of inconsistency between a point query and an element query of the updated hybrid query.

11. The method of claim 10, further comprising:
determining a value of the point-element inconsistency loss,
wherein the determining of the value of the point-element inconsistency loss comprises:
obtaining point-level information and element-level information by transforming the point query and the element query of the updated hybrid query, respectively;
obtaining pseudo-element-level information by fusing coordinate point information, in the point-level information, belonging to a same map element; and
determining the value of the point-element consistency loss based on the pseudo-element-level information and the element-level information such that it represents a level of risk of inconsistency between the pseudo-element level information and the element level information.

12. The method of claim 10, wherein the loss function used by the hybrid decoder during the training process further comprises at least one of a semantic segmentation loss, a classification loss, a point regression loss, a point orientation loss, or a mask loss.

13. An electronic device, comprising:
at least one processor; and
at least one memory storing computer-executable instructions,
wherein, when the instructions are executed by the at least one processor, the at least one processor is configured to:
extract a bird's-eye view (BEV) feature map based on the input data;
determine map information through a hybrid decoder based on the BEV feature map and a hybrid query; and
construct a high-definition (HD) map corresponding to the input data based on the map information,
wherein the HD map comprises a plurality of map elements,
wherein the map information comprises coordinate information and class information of the plurality of map elements,
wherein each of the plurality of map elements comprises an area formed by a plurality of coordinate points in the HD map,
wherein the hybrid query comprises a plurality of hybrid features,
wherein each of the plurality of hybrid features comprises a point feature and an element feature corresponding to a map element,
wherein the point feature represents information associated with each coordinate point of the map element, and
the element feature represents information associated with the map element.

14. A computer-readable storage medium storing instructions, wherein the instructions, when executed by at least one processor, cause the at least one processor to implement the method of claim 1.

15. The method of claim 1, further comprising:
using at least one sensor to collect sensor data as the input data.

16. The electronic device of claim 13, wherein, in the determining of the map information through the hybrid decoder based on the BEV feature map and the hybrid query, the at least one processor is further configured to:
decompose the hybrid query into a first point query and a first element query, wherein the first point query comprises a first point feature corresponding to each coordinate point of each map element, and the first element query comprises a first element feature corresponding to each map element;
determine a second point query and a second element query, based on the BEV feature map, the first point query, the first element query, and current map information;
updating the hybrid query by fusing the second point query and the second element query; and
iteratively update the current map information based on the BEV feature map and the updated hybrid query to generate final map information,
wherein in the constructing of the HD map corresponding to the input data based on the map information, the at least one processor is further configured to:
construct the HD map corresponding to the input data based on the final map information.

17. The electronic device of claim 16, wherein in the determining of the second point query and the second element query, based on the BEV feature map, the first point query, the first element query, and the current map information, the at least one processor is further configured to:
for each of a plurality of anchor points, determine a second point feature based on the BEV feature map, the first point feature, and coordinate information of a corresponding anchor point, wherein the corresponding anchor point comprises a coordinate point corresponding to the first point feature;
obtain the second point query by fusing determined second point features;
for each of the map elements, determine a second element feature of a corresponding map element, based on the BEV feature map, a first point feature of the corresponding map element, and coordinate information of each of a plurality of anchor points of the corresponding map element; and
obtain the second element query by fusing determined second element features.

18. The electronic device of claim 17, wherein in the determining of the second point feature based on the BEV feature map, the first point feature, and the coordinate information of the corresponding anchor point, for each of the plurality of anchor points, the at least one processor is further configured to:
for each of the plurality of anchor points, determine a plurality of sampling points associated with the corresponding anchor point on the HD map, based on the coordinate information of the anchor point and the first point feature;
obtain a third point feature through fusion based on the BEV feature map and coordinate information and a weight of each of the plurality of sampling points; and
determine the second point feature based on the first point feature and the third point feature.

19. The electronic device of claim 18, wherein in the determining of the plurality of sampling points associated with the corresponding anchor point on the HD map, based on the coordinate information of the anchor point and the first point feature, for each of the plurality of anchor points, the at least one processor is further configured to:
determine a fourth point feature based on the coordinate information of the corresponding anchor point and the first point feature;
determine a sampling offset and the weight of each of the plurality of sampling points based on the fourth point feature, wherein the sampling offset represents a degree of positional offset of a sampling point corresponding to the anchor point; and
determine coordinate information of each of the plurality of sampling points, based on the coordinate information of the anchor point and the sampling offset of each of the plurality of sampling points.

20. The electronic device of claim 13, wherein a loss function used by the hybrid decoder during a training process comprises a point-element consistency loss,
wherein the point-element consistency loss is used to represent a level of risk of inconsistency between a point query and an element query of the updated hybrid query.
